(19) United States
(12) Patent Application Publication
(10) Pub. No.: US 2002/0144951 A1
(43) Pub. Date: Oct. 10, 2002

(54) Modification of soy flour proteins for producing coagulants in papermaking and waste water treatment applications

(76) Inventors: Jawed Sarkar, Naperville, IL (US); Manian Ramesh, Lisle, IL (US)

Correspondence Address: Michael B. Martin, Patent & Licensing Department, ONDEO Nalco Company, ONDEO Nalco Center, Naperville, IL, 60563-1198, US

(21) Appl. No.: 09/742,605

(22) Filed: Dec. 21, 2000

(51) Int. Cl. C02F 1/52

(52) U.S. Cl. 210/730

(57) ABSTRACT

Compositions and methods for treating water are provided. Pursuant to the present invention, a modified protein coagulant composition for treating water is provided that includes a quaternized protein having a protein and a cationic monomer. The present invention has been found useful for treating industrial waters relating to, for example, the paper, mining, food, agriculture, and waste treatment industries.

### BACKGROUND OF THE INVENTION

The present invention relates generally to water treatment. More specifically, the present invention relates to methods and compositions of modified protein coagulants that include a quaternized protein having a protein and a cationic monomer.

Coagulants are known and used to treat water for a variety of different coagulant applications, such as, waste water clarification, turbidity reduction, and color removal. These applications can be utilized to treat a variety of different industrial waters, such as those relating to the agricultural, paper, and food industries.

Known coagulants are effective at treating water because of their cationic charge properties. Of those known, synthetic coagulants are extensively used, including those containing acrylamide-based polymers. However, synthetic coagulants, such as, those containing acrylamide-based polymers, are not readily biodegradable. This can have an impact on the extent to which such coagulants can be utilized due to the layers of local, state, and federal environmental regulations pertaining to industrial process waters.

Because of its biodegradable nature, a natural source material(s) is in large demand for use in industrial applications. However, difficulties exists with such use of natural source materials, for example, soy proteins, because of their insolubility in water which makes them effectively impractical to use, for example, in a variety of different industrial water treatment applications.

A need, therefore, exists to develop an improved coagulant that is derived from a renewable and natural source, less costly to produce, and is readily biodegradable.

### SUMMARY OF THE INVENTION

The present invention provides compositions and methods for treating water. More specifically, the present invention provides compositions and methods for a modified protein coagulant capable of treating water to, for example, reduce turbidity, remove color, clarify waste water and perform other like water treatment applications. Unlike conventionally utilized synthetic coagulants, the modified protein coagulant of the present invention is derived from a natural and renewable protein source, such as, a soy protein. The compositions and methods of the present invention can be utilized to effectively treat industrial waters, such as those relating to the paper, mining, waste treatment, emulsion breaking applications, and other industrial waters.

In an embodiment, the present invention provides a modified protein coagulant which comprises a quaternized protein including a protein and a cationic monomer.

In another embodiment, the present invention provides a method of producing a modified protein coagulant for treating water which comprises the steps of: forming an aqueous suspension containing a soy protein; adding a cationic monomer to the aqueous suspension; and quaternizing the protein.

In a further embodiment, the present invention provides a method for treating water which comprises the steps of: providing a quaternized protein including a protein and a cationic monomer; and adding an effective amount of the quaternized protein to the water.

It is therefore an advantage of the present invention to provide a modified protein coagulant capable of treating water.

Another advantage of the present invention is to provide a method for producing a modified protein coagulant for treating water.

A further advantage of the present invention is to provide a method of treating water with a modified protein coagulant.

Yet another advantage of the present invention is to provide an improved coagulant derived from a renewable and natural protein source.

Additional features and advantages of the present invention are described, and will be apparent from, the detailed description of the presently preferred embodiments of the figures.

### BRIEF DESCRIPTION OF THE FIGURES

FIG. 1 illustrates graphically the turbidity reduction performance of a modified protein coagulant of the present invention in comparison to synthetic water treatment agents.

FIG. 2 illustrates graphically the turbidity reduction performance of examples of modified protein coagulants of the present invention.

FIG. 3 illustrates graphically the turbidity reduction performance of examples of modified protein coagulants of the present invention at varying dosages.

FIG. 4 illustrates graphically the turbidity reduction performance of examples of a synthetic flocculent together with varying dosages of modified protein coagulants of the present invention.

FIG. 5 illustrates graphically the turbidity reduction performance of a soy flour and a synthetic flocculent.

FIG. 6 illustrates graphically the turbidity reduction performance of a soy flour and a synthetic coagulant.

FIG. 7 illustrates graphically the color removal performance a modified protein coagulant of the present invention.

### DETAILED DESCRIPTION OF THE PRESENTLY PREFERRED EMBODIMENTS

The present invention provides improved coagulant compositions and methods for producing and using the same to treat water. More specifically, the present invention provides modified protein coagulant compositions and method for producing and using the same to treat water by, for example, reducing turbidity, removing color, clarifying waste water, and other like applications. The modified protein coagulant of the present invention provides a coagulant derived from a renewable and natural source, such as a soy protein. With this make-up, the present invention can be effectively utilized to treat water in a variety of different industrial applications, such as those relating to the food, medical, paper, mining, waste treatment industries, and other industries.

In an embodiment, the present invention includes a modified protein coagulant composition that includes a quaternized protein having a protein and a cationic monomer. In an embodiment the protein is a soy protein, such as a soy flour, soy meal, or mixtures thereof.

As discussed below, a number of protein source materials that are commercially available can be used. These materials include soy protein available from Central Soya Company, Inc., namely, PROMINE 3275, 3210, 3230, 4950, 4930, and 4870. The Promine 3275 product, for example, includes amino acids, such as Lysine, Methionine, Cystine, Threonine, Leucine, Isoleucine, Phenylalanine, Tyrosine, Tryptophane, Histidine, and Valine. The amino acid content based on 100 grams of protein contains Lysine at 6.2 grams, Methionine at 1.2 grams, Cystine at 1.2 grams, Threonine at 4.0 grams, Leucine at 7.7 grams, Isoleucine at 4.2 grams, Phenylalanine at 5.0 grams, Tyrosine at 3.5 grams, Tryptophane at 1.1 grams, Histidine at 2.6 grams and Valine at 4.3 grams. However, the present invention is not limited by the type of protein and can include any suitable protein, such as, any suitable natural and/or vegetable-based protein.

As previously discussed, the modified protein coagulant includes a cationic monomer. The present invention is limited by the type of cationic monomer only to the extent that the cationic monomer must be capable of effectively quaternizing the protein, that is, the modified protein has a cationic charge sufficient enough to be utilized as a coagulant.

In an embodiment, the cationic monomer includes a non-acrylamide cationic monomer. The non-acrylamide cationic monomer can include a cationic monomer other than an acrylamide-based monomer. For example, the non-acrylamide cationic monomer can include quaternary ammonium salts having a variety of different substituent groups, other than acrylamide groups, such as, alkyl, aryl, halogen, epoxides, and other like groups. As previously discussed, the acrylamide-based coagulants are not readily biodegradable. An advantage of the present invention is to provide a coagulant derived from a renewable and natural source that is effectively biodegradable.

In an embodiment, the cationic monomer is selected from the group of 3-chloro 2-hydroxypropyltrimethyl ammonium chloride, 4-chlorobutene trimethyl ammonium chloride, 2,3 epoxypropyltrimethyl ammonium chloride, glycidyl trimethyl ammonium chloride, and mixtures thereof. In a preferred embodiment, the cationic monomer is 3-chloro 2-hydroxypropyltrimethyl ammonium chloride.

The present invention provides a method for producing a modified protein coagulant. In an embodiment, the method includes the steps of forming an aqueous suspension that contains a protein source, such as, a soy protein, adding a cationic monomer to the aqueous suspension, and quaternizing the protein. The method of producing the modified protein coagulant of the present invention is not limited to any specific synthesis procedure such that it can include a variety of different and amounts of reagents and reaction steps provided that the protein source material, such as, soy protein, is effectively quaternized.

In an embodiment, the modified protein coagulant has a cationic charge, that is, it is positively charged. In an embodiment, the cationic monomer is added to the aqueous suspension in an amount equaling a ratio of cationic monomer to protein of at least about 2.9:1 by weight of protein. Alternatively, the ratio of cationic monomer to protein is at least about 4.12:1 by weight of protein.

However, the present invention is not limited by the amount of cationic monomer that is added to the protein suspension provided that the amount of cationic monomer is sufficient enough to effectively quaternize the protein, such as to have an effective charge for treating water. As discussed below, the amount of cationic monomer effects the charge of the modified protein. The inventors have discovered that the charge of the modified protein positively increases as the amount of the cationic monomer is increased.

In an embodiment, the method further includes the step of solubilizing the protein by one of an enzymatic treatment and chemical treatment prior to the treatment step. However, the inventors have discovered that the protein effectively solubilizes during quaternization. Thus, the additional solubilizing step may not required.

In an embodiment, the method further includes performing dialysis of the quaternized protein. The inventors have discovered that the dialysis step effects the charge of the modified protein coagulant. As demonstrated below, the dialysized modified proteins were more positively charged than the undialysized modified proteins. This charge effect is suggested from the removal of salts and other impurities during dialysis. Any suitable dialysis procedure can be utilized.

Alternatively, the method includes adding an alkaline agent during quaternization of the protein. It is suggested that the alkaline addition will alleviate the need of dialysis. This is important because dialysis on a commercial scale may not be feasible. The alkaline agent can include any suitable and amount of alkaline agent, such as, sodium hydroxide.

The present invention provides a method for treating water utilizing the modified protein coagulant. The modified protein coagulant can be added in any suitable amount. In addition, it can be utilized for a variety of different water treatment applications.

In an embodiment, the modified protein coagulant of the present invention is utilized for turbidity reduction, color removal, and waste water clarification. For example, it can be utilized to reduce turbidity of paper pulp filtrate, remove color from paper process stream, and clarify waste water, such as, meat processing and agricultural waste water.

In an embodiment, the modified protein coagulant is added in an amount of at least about 0.2 lb/ton of dry solids to reduce turbidity. In an embodiment, the modified protein coagulant can be added in an amount of at least about 100 ppm to remove color. As previously discussed, the present invention is not limited in its use of treating water.

### Modified Protein Synthesis Examples

The modified protein of the present invention was prepared under various laboratory and process scale conditions to demonstrate the effectiveness of the modified protein to treat water as detailed below. The various illustrated procedures for producing the modified protein are described below in Examples 1 through 6. Test results which indicate the effectiveness of the procedures are provided after each of the examples.

### EXAMPLE 1

One gram soy protein, namely, Promine 3275 was separately placed in four 100 ml beakers and suspended in 25 ml distilled water to produce a 4% slurry. In beakers 1, 2, and 3, Protease N, P and Prelature (15 mg each) were added. In beaker 4 (control), no protease was added. All samples and controls were then incubated at 50° C. for 2 hours under mixing. They were dialyzed (6000 MWCO), centrifuged and both soluble and insoluble materials obtained were freeze-dried.

### Test Result 1

TABLE 1
Effect of Proteases on the Solubility of Soy Flour Promine

| Proteases | Product | Soluble Fraction | Insoluble Fraction | Total (g) | Product |
|---|---|---|---|---|---|
| From Amano | Taken (g) | Obtained (g) | Obtainable (g) | Sol + Insol. | Loss (g) |
| N | 1 | 0.8 (80%) | 0.165 (16.5%) | 0.965 | 0.035 (3.5%) |
| P | 1 | 0.83 (83%) | 0.103 (10.32%) | 0.933 | 0.067 (6.7%) |
| Proleather | 1 | 0.76 (76%) | 0.189 (18.9%) | 0.949 | 0.0507 (5.7%) |
| Control (None) | 1 | 0.49 (49%) | 0.3894 (49%) | 0.879 | 0.12 (12%) |

As shown in Table 1, Promine 3275 treated with proteases was 80% soluble compared with only 49% soluble of untreated (control). Dialysis and protease treatment resulted in 3.5% to 12% product losses. As previously discussed, it was discovered that Promine 3275 and other water insoluble soy flours, including soy meal, turned more soluble during quaternization with both glycidyl trimethyl ammonium chloride and 3-chloro 2-hydroxypropyl trimethyl ammonium chloride. Therefore, this suggests that it may not be necessary to solubilize soy protein chemically or enzymatically prior to quaternization.

It should be appreciated that the 3-chloro 2-hydroxypropyl trimethyl ammonium chloride used in the Example 1 and the following examples was a commercially available product from the Dow Chemical Company. This product is hereinafter referred to as Dow Quat 188.

### EXAMPLE 2

A 6.6% suspension of soy flour 4950 was prepared in distilled water by slowly adding soy powder into water under continuous mixing where the pH of the suspension was 7.2. A 3.8 gram suspension containing 0.25 gram soy flour was distributed into several 1 oz. jars. Various amounts of glycidyl trimethyl ammonium chloride (“Quat”) ranging from 0.125 ml to 0.5 ml containing 0.0905 to 0.362 gram based on Quat solids (i.e., a 73% Quat concentration) were added under vigorous mixing and then quickly transferred to a preheated (45° C.) incubator shaker where mixing continued for another 12 hours. During the incubation period, the suspension of soy flour began to solubilize. After the incubation was complete, the samples were equally divided into two groups. One group was dialyzed (MWC 1000) and the other group was not dialyzed. Both dialyzed and un-dialyzed samples were freeze-dried. The weight of dialyzed samples was 80% of the starting weight of soy flour. The weight of un-dialyzed samples was higher (72%) than the weight of the starting soy flour. This could be due to the presence of either un-reacted Quat or low molecular weight (<1000 MWC) components present in soy flour. A known amount of each sample was used for the charge determination using both Muteck and Colloid Colorimetric Titration. Both methods gave very similar data.

### Test Result 2

TABLE 2
EFFECTS OF DOSAGES OF GLYCIDYL TRIMETHYL AMMONIUM
CHLORIDE AND DIALYSIS-ON CHARGE OF 4950 SOY FLOUR

| Soy Flour-4950 | Water added | Quat added | Dialysis | Product Obtained | Charge Type |
|---|---|---|---|---|---|
| Taken (gram) | (gram) | ml or (gram) | Yes/No | (gram) | (meq/g) |
| 0.25 | 3.75 | 0.125 (0.0905) | Yes | 0.203 | Negative |
| | | | | | 0.1545 |
| 0.25 | 3.75 | 0.125 (0.0905) | No | 0.31 | Negative |
| | | | | | 0.0508 |
| 0.25 | 3.75 | 0.25 (0.181) | Yes | 0.208 | Positive |
| | | | | | 0.0492 |
| 0.25 | 3.75 | 0.25 (0.181) | No | 0.43 | Positive |
| | | | | | 0.065 |
| 0.25 | 3.75 | 0.5 (0.362) | Yes | 0.198 | Positive |
| | | | | | 0.3169 |
| 0.25 | 3.75 | 0.5 (0.362) | No | 0.574 | Positive |
| | | | | | 0.1625 |
| 0.25 | 3.75 | 1.0 (0.726) | Yes | 0.182 | Positive |
| | | | | | 0.5711 |
| 0.25 | 3.75 | 1.0 (0.726) | No | 1 | Positive |
| | | | | | 0.1382 |
| 0.25 | 3.75 | 0.0 (0.0 g) | Yes | 0.145 | Negative |
| | | | | | 0.4141 |

The results show (Table 2) that the soy flour charge changed from negative 0.414 meq/g to positive 0.571 meq/g with a dose of 1 ml or 0.72 g of Quat. Lower positive charges were obtained with lower dosages of Quat. This suggests that for quaternization of 100 grams of soy flour 400 ml (290 grams) of reagent grade glycidyl trimethylammonium chloride is required. However, it should be noted that this amount of Quat is not economically useful in commercial scale quaternization. Therefore, investigations were performed on the commercially available Dow Quat 188.

### EXAMPLE 3

A 6.6% aqueous solution of soy flour (Promine 4950) was prepared as mentioned above. Dow Quat 188 requires sodium hydroxide (NaOH) in order to form an epoxy ring for its reactivity. Therefore, the NaOH equivalent was calculated and found that 0.292 grams of 50% NaOH was required for 1 ml (0.69 gram dry weight) of Dow Quat 188. The effect of various dosages 0.5 ml (0.34 gram) to 1.5 ml (1.03 gram) of Dow Quat 188 to quaternize 0.25 grams of soy flour was investigated. A calculated amount of 50% NaOH (0.145 to 0.438 grams) was added to the above mentioned amounts of Dow Quat 188 prior to its addition to the soy flour suspension. The suspension was vigorously agitated and continued overnight at 45° C. The treated material was equally divided into two groups. Group A samples were dialyzed and Group B samples were not dialyzed. All samples were freeze-dried. Weighted and charge determinations were made as previously discussed.

### Test Result 3

TABLE 3
EFFECTS OF DOSAGES OF DOW QUAT 188 AND DIALYSIS ON CHARGE
OF 4950 SOY FLOUR (4810-157)

| Soy Flour | Water | Quat 188 | NaOH | | Product | Charge |
|---|---|---|---|---|---|---|
| (4950) | added | added ml | added | Dialysis | Obtained | Type |
| Taken (Gram) | (Gram) | or (gram) | gram | Yes/No | (gram) | (meq/g) |
| 0.25 | 3.75 | 0.5 (0.34) | 0.145 | Yes | 0.215 | Positive |
| | | | | | | 0.082 |
| 0.25 | 3.75 | 0.5 (0.34) | 0.145 | No | 0.296 | Positive |
| | | | | | | 0.026 |
| 0.25 | 3.75 | 1.0 (0.69) | 0.292 | Yes | 0.157 | Positive |
| | | | | | | 0.313 |
| 0.25 | 3.75 | 1.0 (0.69) | 0.292 | No | 0.629 | Positive |
| | | | | | | 0.114 |
| 0.25 | 3.75 | 1.5 (1.03) | 0.438 | Yes | 0.203 | Positive |
| | | | | | | 0.517 |
| 0.25 | 3.75 | 1.5 (1.03) | 0.438 | No | 0.899 | Positive |
| | | | | | | 0.136 |
| 0.25 | 3.75 | 0 (0) | 0 | Yes | 0.185 | Negative |
| | | | | | | 0.411 |
| 0.25 | 3.75 | 0 (0) | 0 | No | 0.24 | Negative |
| | | | | | | 0.294 |

The results show (Table 3) that about 80% weight of original product was recovered in dialyzed samples. All un-dialyzed samples contained an excess amount of sodium chloride, which was formed during the quaternization reaction. All samples except the control had a positive charge, which increased upon increasing the amount of Dow Quat 188. A positive charge of 0.517 meq/g was obtained at a dose of 1.5 ml (1.03 grams) to quaternize 0.25 grams soy flour. This suggests that at least 600 ml (412 grams) of Dow Quat is necessary to effectively quaternize 100 grams of soy flour. Based on the above-described dosage results of Quat and Dow Quat 188, scale-up reactions were carried out in a power reactor as discussed below.

### EXAMPLE 4

A 10% aqueous suspension of soy flour was quaternized in a power reactor using different dosages of Quat. The product was recovered and processed in exactly the same manner as described above. The positive charge of the dialyzed product was higher (0.56 meq/grams) where higher doses of Quat were used and lower (0.36 meq/grams) where lower doses of Quat were used.

### Test Result 4

TABLE 4
SCALE-UP QUATERNIZATION REACTION USING GLYCIDYL
TRIMETHYLAMMONIUM CHLORIDE-IN POWER REACTOR
FIRST POWER REACTOR SCALE-UP

| | | Quat added | | | |
|---|---|---|---|---|---|
| | | ml or | | | |
| Soy Flour-4950 | Water added | (solid | Dialysis | Product Obtained | Charge Type |
| Taken (gram) | (gram) | gram) | Yes/No | (gram) | (meq/g) |
| 5 | 50 | 10 (7.3) | Yes | 4.7 | Positive |
| | | | | | 0.36 |
| 5 | 50 | 10 (7.3) | No | 11 | Positive |
| | | | | | 0.15 |

SECOND POWER REACTOR SCALE-UP

| | | | | | |
|---|---|---|---|---|---|
| 3.75 | 37.5 | 11.25 (8.21) | Yes | 3.6 | Positive |
| | | | | | 0.56 |
| 3.75 | 37.5 | 11.25 (8.21) | No | 10.8 | Positive |
| | | | | | 0.179 |

As shown in Table 4, the results confirmed that soy flour could be effectively quaternized using glycidyl trimethyl ammonium chloride.

### EXAMPLE 5

A 10% aqueous solution of soy flour (Promine 4950) and soy meal were separately quaternized in a power reactor under similar conditions as Example 4. Optimal doses of Dow Quat 188 were added based on the experimental results discussed above. In a power reactor, 5 grams of each product was used. To each product, 30 ml (20.7 grams) of Dow Quat 188 and a 50% solution (8.76 grams) of NaOH was added. The reaction was carried out under mixing for 8 hours at 50° C. The soy flour sample turned homogenous and soluble. The sample was divided into two groups in which one group was dialyzed while the other was not dialyzed. The soy meal sample had undissolved residues, which were removed by centrifugation (10,000 rpm). The supernatant obtained was dialyzed. An identical soy meal sample, which also had un-dissolved residues, were removed but the supernatant obtained was not dialyzed. All liquid products were freeze-dried.

### Test Result 5

TABLE 5
SCALE-UP QUATANIZATION REACTION USING DOW QUAT 188
IN POWER REACTOR
FIRST POWER REACTOR SCALE-UP

| | | | NaOH | | | |
|---|---|---|---|---|---|---|
| 4950-Soy | Water | Quat | 50% | | Product | Charge |
| Flour | added | added ml | added | Dialysis | Obtained | Type |
| Taken (gram) | (gram) | or (gram) | (gram) | Yes/No | (gram) | (meq/g) |
| 5 | 50 | 30 (20.7) | 8.76 | Yes | 3.68 | Positive |
| | | | | | | 0.629 |
| 5 | 50 | 30 (20.7) | 8.76 | No | 27.5 | Positive |
| | | | | | | 0.0961 |

TABLE 6
SCALE-UP QUATANIZATION REACTION USING DOW QUAT 188
IN POWER REACTOR
FIRST POWER REACTOR SCALE-UP (4810-184)

| | | Quat | NaOH | | | |
|---|---|---|---|---|---|---|
| Soy | Water | added ml | 50% | | | Charge |
| Meal | added | or (solids | added | Dialysis | Product | Type |
| Taken (gram) | (gram) | gram) | (gram) | Yes/No | (gram) | (meq/g) |
| 5 | 50 | 30 (20.7) | 8.76 | Yes | 2.79 | Positive |
| | | | | | | 0.788 |
| 5 | 50 | 30 (20.7) | 8.76 | No | 20.7 | Positive |
| | | | | | | 0.083 |

As shown in Tables 5 and 6, the recovery of soy flour was 74% and soy meal was 56%. The charge determined of soy flour and meal dialyzed fractions was positive 0.629 and 0.788 meq/grams, respectively. The charge determined in un-dialyzed products was significantly lower than dialyzed products on weight per weight basis. This could be due to the presence of salts (20.7 and 27.5 grams) and other impurities in un-dialyzed products. Further optimization of quaternization process, for example, by adjusting the feeding of NaOH may allow for the minimization of NaCl generation, which is very important, because the dialyzation of commercial scale product may not be feasible.

### EXAMPLE 6

A quaternized soy flour representative of the quaternized soy flours as discussed above was freeze-dried. The dried solid was analyzed by Infrared Spectroscopy and thus identified as a mixture of secondary amides and carbohydrates. There were additional signals in the region assigned to the formation of the quaternary product. The elementary analysis revealed 45% carbon, 7.5% hydrogen, and 11% nitrogen. The gel permeation chromotography (“GPC”) chromatograms obtained were somewhat non-Gaussian having a leading, very high molecular weight (“MW”) region. The Weight Average MW was 57000 atomic mass units.

### Modified Protein Application Examples

To demonstrate the effectiveness of the modified protein coagulant of the present invention to treat water, a number of comparative tests were conducted as identified below in Examples 7 and 8. The comparative tests were conducted on the modified protein in a variety of known and commercially available synthetic coagulants and flocculants.

### EXAMPLE 7

### Test Result 7

In order to establish the applications of quaternized soy flour for improvement of retention, three different types of paper furnishes were tested: (1) 25% Coated Broke containing mixture of 75% HWK+SWK [1:1], (2) Standard Alkaline, and (3) Coated Broke only.

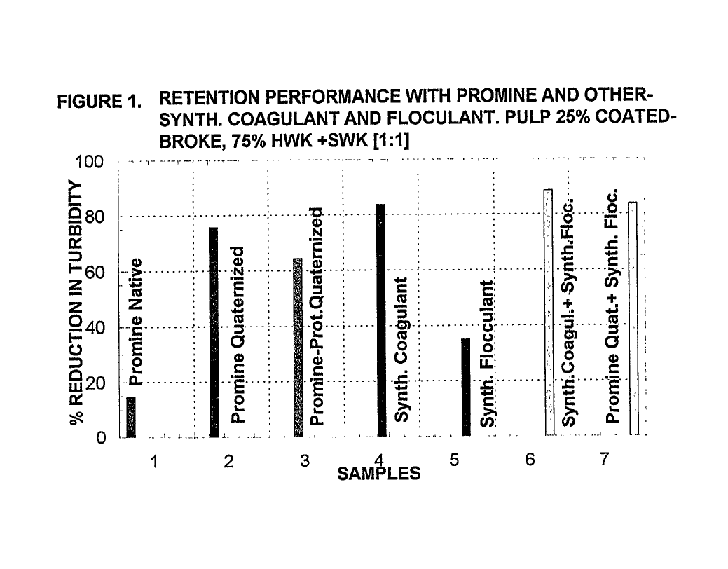

The pulp furnish (1) was treated with an equal dose of Promine 3275 quaternized and Promine native (non-quaternized). Promine 3275 was first treated with a protease and then quaternized. The reduction in pulp filtrate turbidity which measures the improvement in retention was recorded. As indicated in FIG. 1, the results show a significant reduction in pulp filtrate turbidity with Promine 3275 quaternized and Promine 3275 first treated with a protease and then quaternized. While there was no reduction in pulp filtrate turbidity with native Promine 3275 (FIG. 1), it appears that there should be no need to treat Promine 3275 with a proteolytic enzyme in order to improve its solubility prior to quaternization, since it was observed that Promine 3275 by itself became soluble during the quaternization reaction. In paper making practice a synthetic coagulant is generally added either alone or in combination with an anionic flocculent. Therefore, for comparative purposes we included a highly charged (7.3 meq/grams) epichlorohydrin-dimethylamine (“epiDMA”) coagulant and a 30 mole % anionic flocculant as illustrated in FIG. 1.

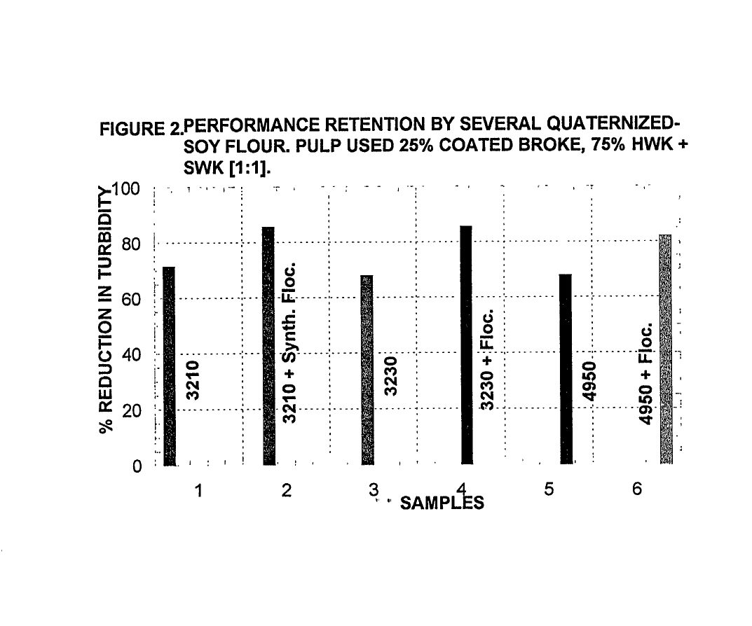

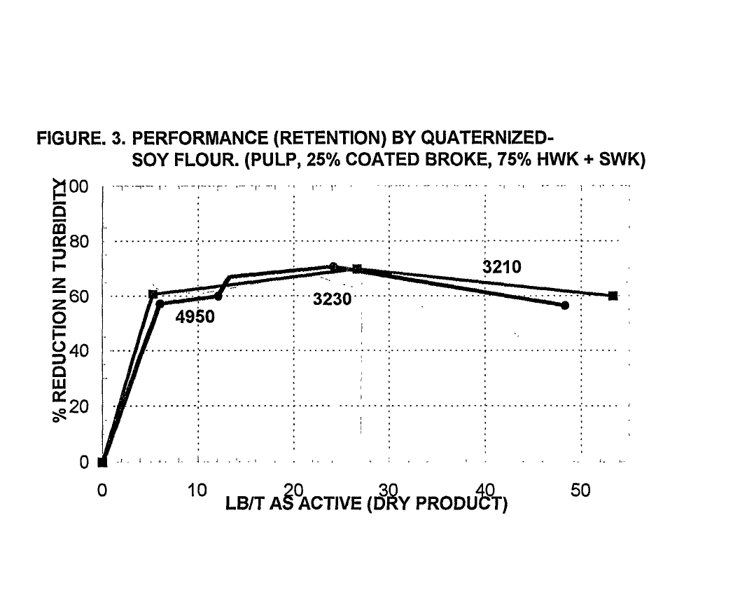

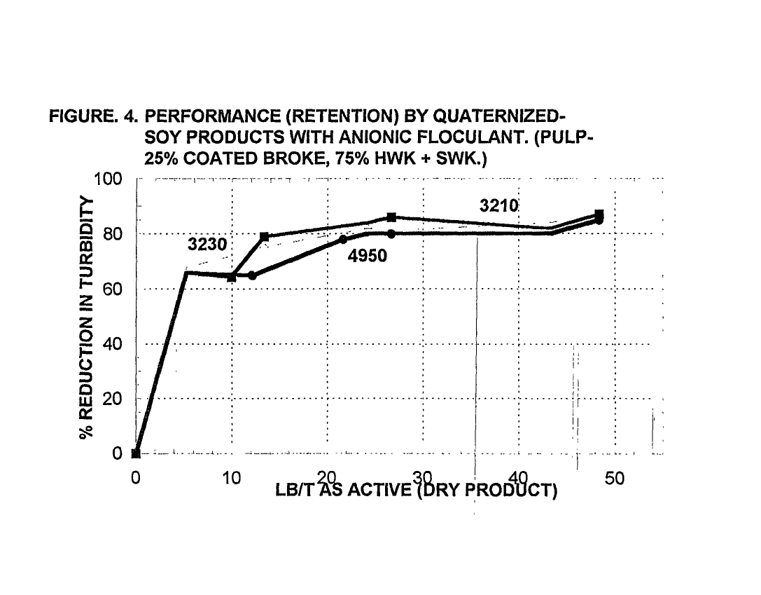

To confirm these findings, other soy protein samples, namely, 3210, 3230 and 4950, as received from Central Soya, were also quaternized and their performances were investigated. As illustrated in FIG. 2, the results show that each of the quaternized soy proteins significantly improved the retention. In order to optimize the dosages of quaternized 3210, 3230 and 4950, various amounts ranging from 9 to 80 mg./3.0 grams dry pulp or 5 to 53 lb/t were investigated either alone or in combination with an anionic flocculant in an amount of 2 lb/t. As illustrated in FIGS. 3 and 4, the results show a rapid decrease in pulp filtrate turbidity (higher retention) at lower dosages of at least about 9 mg. There was no further significant decrease in turbidity by increasing the dosages of quaternized soy beyond 9 mg. In fact, at higher dosages (above 50 mg) some increase in filtrate turbidity (decrease retention) was found. As discussed below, further experiments were conducted at decreased dosages of quaternized soy flour 4950 to further ascertain its performance at lower dosages.

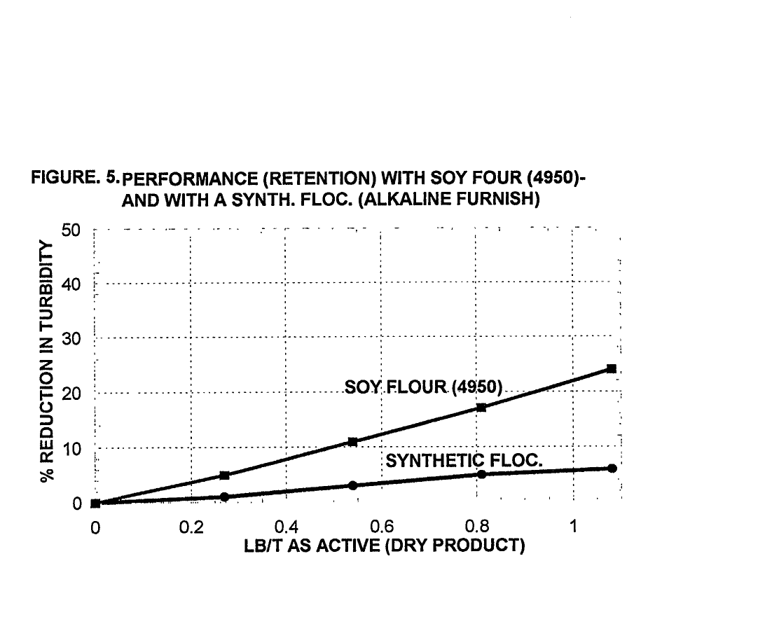

In order to establish that quaternized soy flour is an effective coagulant and further ascertain its effect at lower dosages, experiments were carried out using standard alkaline furnish (2). An anionic 30 mole % flocculant was also included in this study. Tests were carried out using a standard Britt Jar method where 0.5% pulp slurry was added to the Britt Jar, mixed at 750 rpm for 30 seconds and drained. The drained filtrate collected for 30 seconds was used for turbidity measurement. As illustrated in FIG. 5, the results show that no reduction in turbidity was achieved by flocculent. These results are not surprising because anionic flocculant is generally used with a coagulant to improve the drainage. The turbidity was continually decreased by quaternized soy flour (4950) as the dose increased from 0.2 to 1 lb/t. For example, a reduction in turbidity of 22% results from a 1 lb/t dose of quaternized soy flour (4950). Indeed, these results confirm that a lower dose of quaternized soy flour may be used.

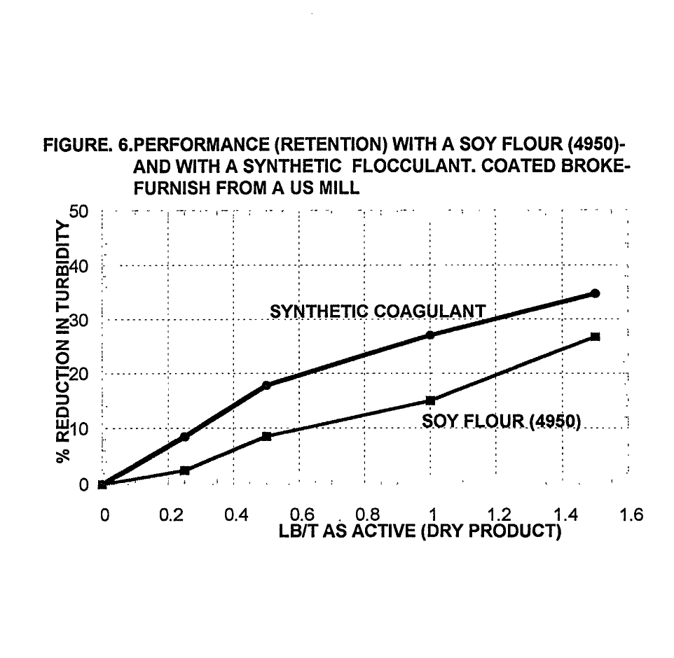

As illustrated in FIG. 6, the performance of quaternized soy flour (4950) was also investigated using only coated broke. The performance measured in percent reduction of turbidity. The results show (FIG. 6) that the reduction in turbidity depended upon the dosages. For example, about 25% turbidity was reduced by 1.5 lb/t dose. It is concluded that quaternized soy flour could be used as a coagulant for the improvement in retention for different types of pulp furnishes. This can also be used with an anionic flocculent where drainage improvement is needed.

### EXAMPLE 8

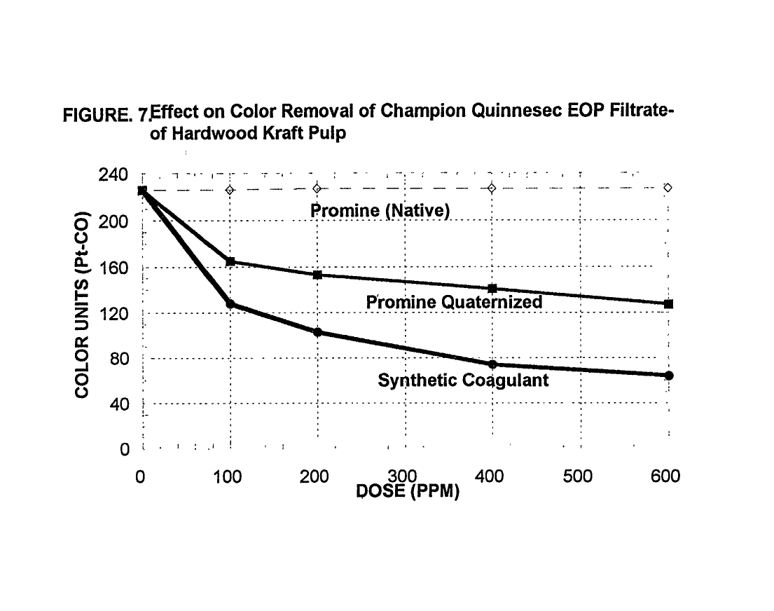

As indicated in FIG. 7, a color effluent from hardwood kraft line of a paper mill was treated with varying dosages of Promine 3275 ranging from about 100 to about 800 ppm as active. The Promine 3275 was quaternized as previously discussed. Performance of these Promine Quaternized preparations was compared the conventional synthetic epiDMA coagulant for color removal application.

### Test Result 8

As illustrated in FIG. 7, each of the quaternized soy flour preparations removed color and performed similarly. Native soy flour did not perform at all. The synthetic epiDMA coagulant performed slightly better than quaternized soy flour. The synthetic epiDMA has 7.3 me/g charge whereas, quaternized soy flour preparations had an average charge of 0.6 meq/g. Thus, the performance is not based strictly on charge.

### EXAMPLE 9

The modified protein coagulants of the present invention can also be utilized in the meat processing and agricultural industry. For example, it can be utilized to treat slaughterhouse and farm wastewater with non-acrylamide polymers. The solids separated or clarified from this application could be effectively reused by mixing them with the feed. The residues recovered should have a high concentration of nutrients.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that all such changes and modifications be covered by the intended claims.

What is claimed is:

1. A modified protein coagulant composition, the composition comprising:
a quaternized protein including a protein and a cationic monomer.

2. The composition of claim 1 wherein the protein is a soy protein selected from the group consisting of soy flour, soy meal, and mixtures thereof.

3. The composition of claim 1 wherein the cationic monomer is a non-acrylamide cationic monomer.

4. The composition of claim 1 wherein the cationic monomer is selected from the group consisting of 3-chloro 2-hydroxypropyltrimethyl ammonium chloride, 4-chlorobutene trimethyl ammonium chloride, 2, 3 epoxypropyltrimethyl ammonium chloride, glycidyl trimethyl ammonium chloride, and mixtures thereof.

5. The composition of claim 1 wherein the cationic monomer is 3-chloro 2-hydroxypropyltrimethyl ammonium chloride.

6. A method of producing a modified protein coagulant for treating water, the method comprising the steps of:
forming an aqueous suspension containing a protein;
adding a cationic monomer to the aqueous suspension; and
quaternizing the protein.

7. The method of claim 6 wherein the cationic monomer is selected from the group consisting of a non-acrylamide cationic monomer, 3-chloro 2-hydroxypropyltrimethyl ammonium chloride, 4-chlorobutene trimethyl ammonium chloride, 2, 3 epoxypropyltrimethyl ammonium chloride, glycidyl trimethyl ammonium chloride, and mixtures thereof.

8. The method of claim 6 further comprising the step of solubilizing the protein by one of an enzymatic treatment and chemical treatment prior to the treatment step.

9. The method of claim 6 wherein the adding step includes adding a ratio of cationic monomer to protein of at least about 2.9:1 by weight of protein.

10. The method of claim 6 wherein the adding step includes adding a ratio of cationic monomer to protein of at least about 4.12:1 by weight of protein.

11. The method of claim 6 further comprising forming a quaternized protein having a cationic charge.

12. The method of claim 6 further comprising adding an alkaline agent during quaternization of the protein.

13. The method of claim 6 further comprising performing dialysis of the quaternized protein.

14. A method for treating water, the method comprising the steps of:
providing a quaternized protein including a protein and a cationic monomer; and
adding an effective amount of the quaternized protein to the water.

15. The method of claim 14 wherein the cationic monomer is selected from the group consisting of non-acrylamide cationic monomer, 3-chloro 2-hydroxypropyltrimethyl ammonium chloride, 4-chlorobutene trimethyl ammonium chloride, 2, 3 epoxypropyltrimethyl ammonium chloride, glycidyl trimethyl ammonium chloride, and mixtures thereof.

16. The method of claim 14 further comprising adding a suitable flocculant together with the quaternized protein to the water.

17. The method of claim 14 further comprising the step of reducing turbidity in the water.

18. The method of claim 17 wherein the amount of quaternized protein is at least about 0.2 lb/ton of dry solids in the water.

19. The method of claim 14 further comprising the step of removing color from the water.

20. The method of claim 19 further comprising clarifying waste water.
